(19) United States
(12) Patent Application Publication
(10) Pub. No.: US 2012/0300957 A1
(43) Pub. Date: Nov. 29, 2012

(54) MOBILE SOUND REPRODUCING SYSTEM

(76) Inventor: Mikhail LYUBACHEV, Saint-Petersburg (RU)

(21) Appl. No.: 13/295,047

(22) Filed: Nov. 12, 2011

(30) Foreign Application Priority Data
May 27, 2011 (RU) 2011121330

(51) Int. Cl. H04W 4/04

(52) U.S. Cl. 381/81

(57) ABSTRACT

Proposed device relates to sound playback. Playback device is made in the shape of a polyhedron and is equipped with preferably gravity-controlled switch for operation modes and reception of input signals selection. The channel assigned is directly linked to the side the unit stands on as a base. When placed on front or back sides, the unit is turned off.

The proposed device relates generally to sound reproduction hardware, to sound-amplifying and reproducing devices in particular.

### PRIOR ART

Sound reproduction systems are used to amplify acoustic playback. To enhance ease of use, improve consumer qualities, reproducing hardware, besides acoustic electromagnetic units (speakers), nowadays is mainly made active, i.e. containing at least an amplifier and sometimes a power supply unit.

There are active sound reproducing systems equipped except for the amplifier, with a device for radio input (e.g., BLUETOOTH®, WiFi®).

E.g., the U.S. Pat. No. 7,406,294. The unit allows to transmit audio signal via radio channel to the end device.

The U.S. Pat. No. 7,925,307 describes assembly common for the patent family for sound reproduction devices that enhance receiving and transmitting signals to end units via radio channel.

Disadvantages of such units are complexity and lack of mobility.

The U.S. Pat. No. 7,653,344 describes most similar assembly of a sound playback device, allowing to receive signals from a large number of devices (not simultaneously) and transfer them to end devices over radio channel.

Disadvantages of units are complexity and lack of mobility.

This devise was chosen as prior art.

Technical result attained by the proposed device is enhancing convenience, mainly by simplifying the design by denying all controls on the outer surfaces thereof, mobility, due to absence of wires, possibility to install the device in any room without additional special means, fasteners, tools and labor, external power supply, expanding the range of devices of this type, increasing consumer qualities.

Known devices do not allow to fully or in part reach these results.

### DESCRIPTION OF INVENTION

### Brief Summary

Proposed hereinafter is a sound reproducing system made in form of a polyhedron, with the possibility to use each side as base when placing the device on floor, table, any other horizontal surface, with the possibility of receiving an input multi-channel signal over a wireless (mainly radio) channel, with that application of the channel received or operation mode unambiguously depends on the unit spatial orientation (spatialization), i.e., which side of the device is used as the base. To switch channel or operation mode it is enough to simply turn the unit and use another side as base.

### DESCRIPTION OF DRAWINGS

FIG. 1 shows the unit in the shape of a hex (with different-sized sides) in operating position (on one of sides), front view.

FIG. 2 shows the unit in the shape of a hex (with different-sized sides) in operating position (on one of sides), back view.

FIG. 3 shows appearance of the unit in the shape of a hex, off-mode position—lying on front side.

FIG. 4 shows the possible input sources.

FIG. 5a shows one of possible configurations of the device in an apartment.

FIG. 5b shows another possible configuration of the device in an apartment.

FIG. 5c shows still another possible configuration of the device in an apartment.

### DESIGNATIONS USED IN FIGURES

1—unit body;

2—sides that can be used as base;

3—face side of the unit;

4—back side of the unit;

5—socket for power supply and battery charging;

6—schematic representation of device hex version;

7—signal source.

### DETAILED DESCRIPTION

Proposed herein is a sound reproducing system made in form of a polyhedron, with the possibility to use each side as base with the possibility of receiving an input multi-channel signal over a wireless (mainly radio) channel, with possibility of that selection and application of the channel received or operation mode unambiguously depending on the unit spatialization, i.e., which side is used as the base.

The unit is in a switched off mode when placed on front or back side of the unit.

The unit can be powered on mode can be achieved either by placing the device in a certain side as a base (by assigning one side to be used as base for switching on) or by turning on one of radiochannels or operation modes.

Input signal is preferably received via radiochannel. However, input signal may be transmitted by ultrasound, sound, infrared or another well-known type of wireless channel.

The number of sides of the device is selected basing on number of channels and operation modes.

Switching means may contain one or more gravity sensors that react to unit's position.

Position of the unit may be detected with an optical, ultrasound, super-high-frequency sensor or any type of sensor suitable by accuracy, size, efficiency and other operational parameters.

Power supply means can operate both connected to mains and in standalone mode—it may contain an autonomous power source, such as a rechargeable battery. Switching means is performed with ability to directly connect to one of a number of possible channels and/or activate one of several operation modes of the unit depending on what side of the unit is used as the base.

Tuning to another channel and/or changing to another operational mode occurs after the unit has changed its spatial orientation, e.g. has been turned and placed on another side as a base.

Installation on wall or another support is possible. In this case operation mode and/or channel received depends on what side of the unit is facing downwards. This implementation of the unit requires to provide suspending mechanism with the possibility to rotate the unit along one or more axes.

Unit Operation.

Initial position is that the unit is on its shut-off side—say, face side or back side.

In order to switch it on, select the mode in which the unit is to operate (for a hex body)—“MONO”, “LEFT FRONT”, “CENTER FRONT”, “RIGHT FRONT”, “LEFT REAR”, “RIGHT REAR” and select the corresponding side as the base. At this moment power supply is switched on and the spatial-orientation-dependent switch engages necessary channel. Input channel is received from a designated channel, amplified in power amp and played back via speakers. In order to change received signal the body is to be turned and placed on corresponding side as a base. After work the unit is to be placed on its face or back side to be switched off.

### EXAMPLE 1.

### Assigning Channels to Sides Unit in the form of an octahedron—a pyramid with triangle bottom.

Front side—device (unit) is turned off.

Side 1—Mono mode.

Side 2—Left Front mode.

Side 3—Right Front mode.

### EXAMPLE 2

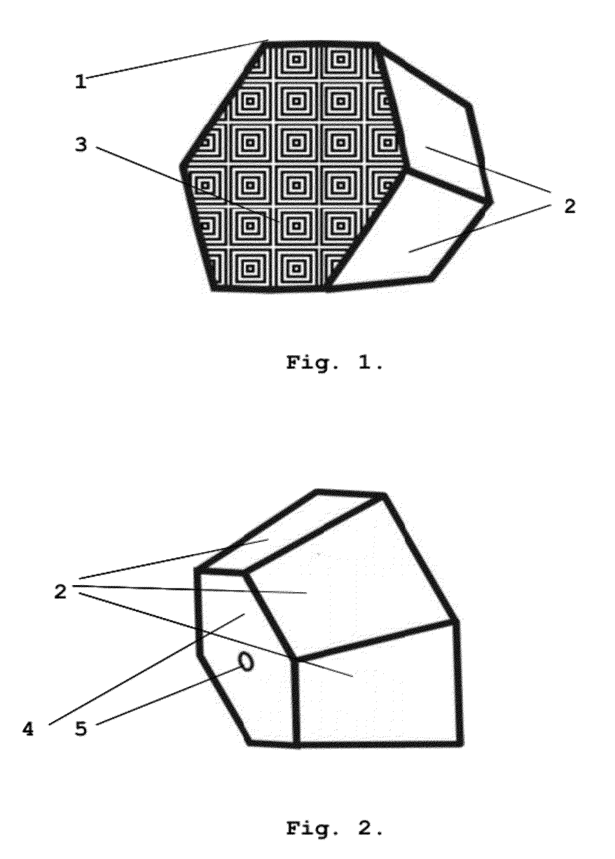

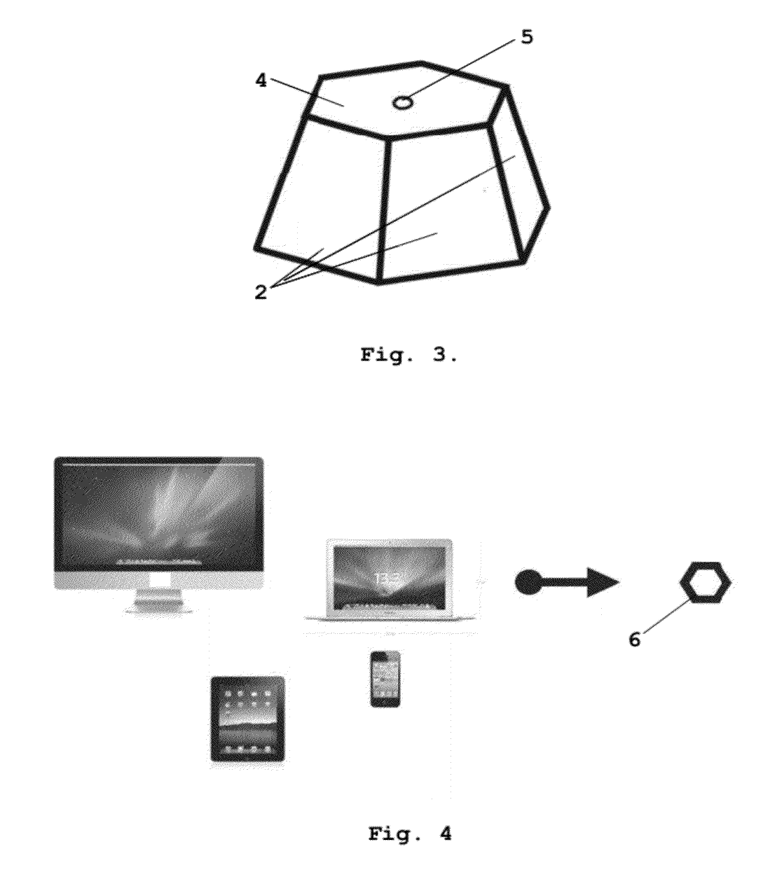

### Assigning Channels to Sides used as Bases (Corresponds to FIG. 1-5)

Unit in the shape of a hexahedron.

Assigning channels to sides.

Front side—device (unit) turned off.

Back side—device (unit) turned off.

Side 1—Mono mode.

Side 2—Left Front mode.

Side 3—Center Front mode.

Side 4—Right Front mode.

Side 5—Left Rear mode.

Side 6—Right Rear mode.

Signal source for the unit may be any known device containing one or more output audio channels and wireless network compatible with the wireless network of the device.

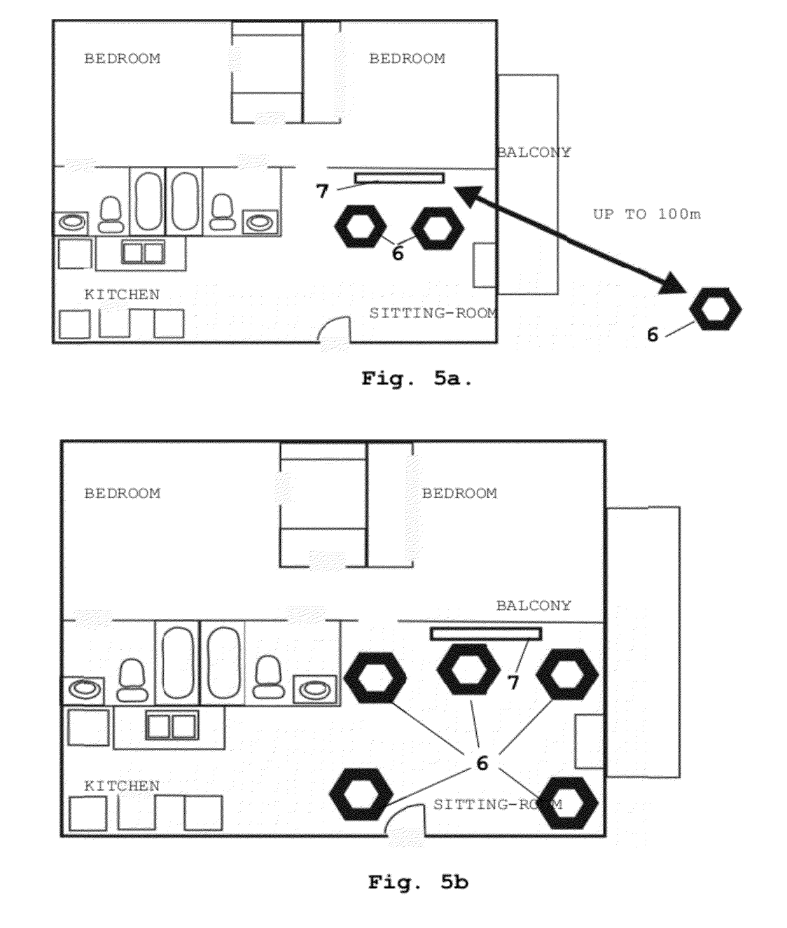

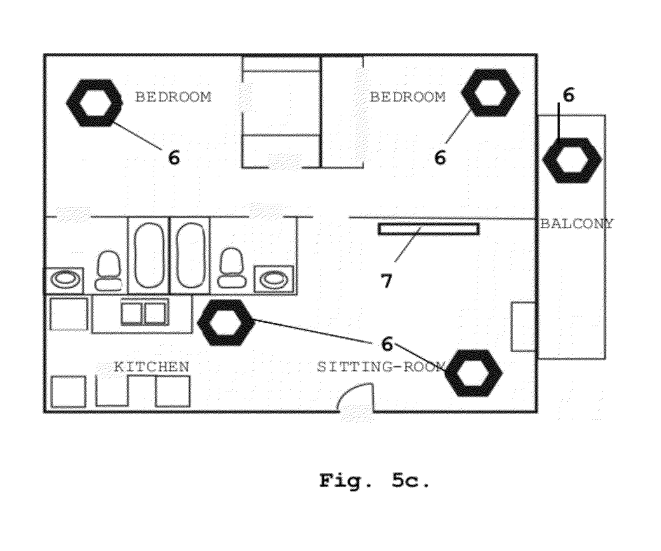

Examples of use of devices (units) are shown in FIG. 5a, 5b, 5c. Source of radio signal is the unit shown close to a room wall. Sound reproducing systems located in different rooms and outside the apartment within radio coverage are switched for receiving different channels of input signal, which enables audio playback on various modes.

I claim:

1. Playback device comprising housing, input signal receiving means, means for switching between several channels of input signal, amplifier of input signal, means for sound playback, power supply, power switchgear,
wherein
said housing is made in the shape of a polyhedron with possibility to use every side, as base;
spatial-orientation-dependent switching means is made with ability to select reception of one of several possible channels according to its spatial orientation.

2. Playback device as recited in claim 1, further comprising said spatial-orientation-dependent switching means is made to additionally enable selection of one of several possible device operation modes in accordance to its spatial orientation.

3. Playback device as recited in claim 1 or 2, wherein reception of one of several possible channels or enabling one of several possible device operation modes depends on which downward horizontal surface is used as the base.

4. Playback device as recited in claim 3, wherein the device turns off when placed on one of sides.

5. Playback device as recited in claim 4, wherein the device turns off when placed on face side.

6. Playback device as recited in claim 4, wherein the device turns off when placed on back side.

7. Playback device as recited in claim 1 or 2, wherein the device turns on along with enabling of any channel.

8. Playback device as recited in claim 1 or 2, wherein the input signal is received via radiochannel.

9. Playback device as recited in claim 1 or 2, wherein the number of sides is selected basing on number of channels and operation modes.

10. Playback device as recited in claim 1 or 2, wherein the power supply can work both connected to mains and in standalone mode.

11. Playback device as recited in claim 1 or 2, wherein the switching means is performed with ability to select one of several possible channels or select one of several operation modes of the device depending on what side of the unit is used as the base.

12. Playback device as recited in claim 1 or 2, wherein it is made with possibility of hanging on a stationary support, whereas the suspension device is provided with ability of changing orientation along one or more axes.

13. Playback device as recited in claim 1 or 2, wherein switching device contains one or more gravity-dependent sensors that react to device's spatial orientation.

14. Playback device as recited in claim 1 or 2, wherein switching device contains one or more ultrasonic sensors that react to device's spatial orientation.

15. Playback device as recited in claim 1 or 2, wherein switching device contains one or more optical sensors that react to device's spatial orientation.

16. Playback device as recited in claim 1 or 2, wherein switching device contains one or more radio sensors that react to device's spatial orientation.

17. Playback device as recited in claim 1 or 2, wherein tuning to another channel or changing to another operating mode occurs after the unit has changed its spatial orientation, e.g. has been placed on another side as a base.
